(19) United States
(12) Patent Application Publication
(10) Pub. No.: US 2009/0198592 A1
(43) Pub. Date: Aug. 6, 2009

(54) SMS gifting

(75) Inventor: David Emerson, Overland Park, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Embarq Holdings Company, LLC, Overland Park, KS (US)

(21) Appl. No.: 12/012,132

(22) Filed: Jan. 31, 2008

(51) Int. Cl. G06Q 30/00; H04Q 7/20

(52) U.S. Cl. 705/27; 705/26

(57) ABSTRACT

A SMS gifting system including a computer of a commercial business in communication with a network; the computer generates a purchase authorization code (“PAC”) and an indicia that describes a purchase by a purchaser of goods, services, and gift amounts relating to the commercial business; the computer transmits the generated PAC and indicia to a recipient; a communications device operable by the purchaser receives the information relating to the goods, services, and gift amounts and displays the information to the purchaser, a wireless communications device in communication with the network operable by the recipient to receive and display the generated PAC and indicia; and a store providing the goods, services, and gift amounts of the commercial business, the store receives the generated PAC and indicia and compares the presented PAC to the generated PAC for authorizing the provision at the store of the purchased goods, services, and gift amounts.

### BACKGROUND

People express their appreciation and affection for others in many different ways, such as writing their thoughts in notes and letters and by calling each other to express their thoughts. Another way to express appreciation and thoughtfulness is to take the time to shop and purchase a gift for another and then give it to them as a token of their appreciation. Gifts can be given in various ways.

For example, the traditional way of giving a gift includes going to a store, shopping for the proper gift, and purchasing the gift in person at the store. The gifts are then usually wrapped and either dropped off at a parcel delivery service or may be delivered in person to the desired recipient. One problem with giving gifts this way is that it takes time to go out and shop and purchase the gift and then give the gift to the recipient.

For efficiency and convenience sake, some gifts may be purchased through the telephone or Internet, such as actual cards, gift cards, and the like. For example, many online commercial websites allow shoppers to purchase merchandise they sell online and then direct where it is to be shipped. This is very efficient and convenient for the purchaser in that it eliminates the wasted time driving to and from a store. During the purchase process, the purchaser may sometimes include a note reflecting their feelings to be included with the shipment. Nevertheless, these gifts still must be thought out in advance to account for the shipping time involved with delivering the gift to the recipient.

Some retailers sell gift cards that may be purchased and given to a recipient as a gift. The gift card is then either shipped or delivered to the recipient who then can use the gift card at the issuer of the gift card. This requires that the purchaser of the gift card must arrange for the delivery of the gift card or deliver it in person. Either way, some time is involved in delivering the gift card to the recipient. Thus, some lead time is required to be able to timely deliver the gift card in time for a particular occasion or desired date. Nevertheless, these means do not provide for a way to spontaneously provide a gift to a recipient. For example, if a person recently learns that a friend is en route to their favorite coffee shop, there isn't a way to arrange for their favorite drink to be gifted to the friend at the coffee shop without the added time of meeting them at the coffee shop personally and buying them their favorite latte, for example.

### SUMMARY

The problems presented with these established means of gifting are solved by an improved SMS gifting (“SMS gifting system”) that operates with a recipient's wireless communications device. In one embodiment, the present SMS gifting system includes a central online computer of a commercial business in communication with a network including a processor for generating a purchase authorization code and an indicia describing a purchase by a purchaser of at least one of goods, services, and gift amounts relating to the commercial business; a memory for storing information relating to the at least one of goods, services, and gift amounts of the commercial business and the generated purchase authorization code; an input/output unit for transmitting the generated purchase authorization code and indicia describing the purchase of the at least one of goods, services, and gift amounts to a recipient; a communications device in communication with the network the communications device operable by the purchaser and configured to: receive the information relating to the at least one of goods, services, and gift amounts; display the information to the purchaser relating to the at least one of the goods, services, and gift amounts; responsive to purchaser input, purchase the at least one of the goods, services, and gift amounts; a wireless communications device in communication with the network operable by the recipient and configured to: receive the generated purchase authorization code and indicia describing the purchase of the at least one of goods, services, and gift amounts; display to the recipient the generated purchase authorization code and indicia describing the purchase of the at least one of goods, services, and gift amounts; and a store providing the at least one of goods, services, and gift amounts of the commercial business, the store having a computer in communication with the central online computer, the computer including an input/output unit for receiving the generated purchase authorization code and indicia describing the purchase of the at least one of goods, services, and gift amounts; a memory for storing the generated purchase authorization code and indicia describing the purchase of at least one of goods, services, and gift amounts; an input device for accepting a purchase authorization code presented by the recipient; a processor for comparing the presented purchase authorization code to the generated purchase authorization code for authorizing the provision at the store of the purchased at least one of goods, services, and gift amounts.

Preferably, the communications device is a wired or wireless communications device includes an input/output unit configured to communicate with the central online computer to receive the information relating to the at least one of goods, services, and gift amounts; and a display for displaying to the purchaser the information relating to the at least one of goods, services, and gift amounts. Preferably, the presented purchase authorization code is presented by on the recipient's wireless communications device. Preferably, the network is at least one of Internet, Intranet, TDMA network, CDMA network, PCS network, GSM network, WiMAX network, WLAN, data network, packet network private network, PSTN, and VoIP network.

In another embodiment, the present SMS gifting system includes a first store configured to execute a sale of at least one of goods, services, and gift amounts by a purchaser, the first store having a computer in communication with a network, the computer including a processor for generating a purchase authorization code corresponding to the purchased at least one of goods, services, and gift amounts and an indicia describing the purchased at least one of goods, services, and gift amounts; a memory for storing the indicia describing the purchased at least one of goods, services, and gift amounts and the generated purchase authorization code; an input/output unit for transmitting the generated purchase authorization code and the indicia describing the purchased at least one of goods, services, and gift amounts to at least one of the purchaser, the first store, and a second store; a first wireless communications device in communication with the network operable by the purchaser and configured to: transmit at least one of the purchase authorization code and the indicia describing the purchased at least one of goods; and a second wireless communications device in communication with the network operable by the recipient and configured to: receive the generated purchase authorization code and indicia describing the purchase of the at least one of goods, services, and gift amounts; display to at least one of the recipient, the first store, and the second store the generated purchase authorization code and indicia describing the purchase of the at least one of goods, services, and gift amounts.

In yet another embodiment, the present SMS gifting system includes a method for sending to a recipient a purchase authorization code corresponding to a purchased gift by a purchaser including displaying information corresponding to at least one of goods, services, and gift amounts to a purchaser's communications device in communication with a network; selecting at least one of goods, services, and gift amounts on the communications device by the purchaser, purchasing the at least one of goods, services, and gift amounts; responsive to the purchase, generating the purchase authorization code corresponding to the purchase; and transmitting the purchase authorization code and indicia of the purchased at least one of goods, services, and gift amounts to the recipient's communications device.

In still yet another embodiment, the present SMS gifting system includes a system for sending to a recipient a purchase authorization code corresponding to a purchased gift by a purchaser including means for displaying information corresponding to at least one of goods, services, and gift amounts to a purchaser's communications device in communication with a network; means for selecting at least one of goods, services, and gift amounts on the communications device by the purchaser, means for purchasing the at least one of goods, services, and gift amounts; responsive to the purchase, means for generating the purchase authorization code corresponding to the purchase; and means for transmitting the purchase authorization code and indicia of the purchased at least one of goods, services, and gift amounts to the recipient's communications device.

In yet another embodiment, the present SMS gifting system may include a central online computer of a commercial business in communication with an email system for generating a purchase authorization code and indicia describing a purchase by a purchaser of at least one of goods, services, and gift amounts relating to the commercial business and sending the purchase authorization code and indicia to a recipient's wireless communications device or wired communications device. The central computer including a processor for generating a purchase authorization code and an indicia describing a purchase by a purchaser of at least one of goods, services, and gift amounts relating to the commercial business; a memory for storing information relating to the at least one of goods, services, and gift amounts of the commercial business and the generated purchase authorization code; an input/output unit for transmitting the generated purchase authorization code and indicia describing the purchase of the at least one of goods, services, and gift amounts to a recipient; a communications device in communication with the network, the communications device operable by the purchaser and configured to: receive the information relating to the at least one of goods, services, and gift amounts; display the information to the purchaser relating to the at least one of the goods, services, and gift amounts; responsive to purchaser input, purchase the at least one of the goods, services, and gift amounts; a wireless or wired communications device in communication with the network operable by the recipient and configured to: receive the generated purchase authorization code and indicia describing the purchase of the at least one of goods, services, and gift amounts in an email format; display the email to the recipient the generated purchase authorization code and indicia describing the purchase of the at least one of goods, services, and gift amounts; and a store providing the at least one of goods, services, and gift amounts of the commercial business, the store having a computer in communication with the central online computer, the computer including an input/output unit for receiving the generated purchase authorization code and indicia describing the purchase of the at least one of goods, services, and gift amounts; a memory for storing the generated purchase authorization code and indicia describing the purchase of at least one of goods, services, and gift amounts; an input device for accepting a purchase authorization code presented by the recipient; a processor for comparing the presented purchase authorization code to the generated purchase authorization code for authorizing the provision at the store of the purchased at least one of goods, services, and gift amounts.

### BRIEF DESCRIPTION OF THE DRAWINGS

Illustrative embodiments of the present invention are described in detail below with reference to the attached drawing figures, which are incorporated by reference herein and wherein:

FIG. 1 illustrates a block diagram of an exemplary network in a system for SMS gifting according to an embodiment of the present invention;

FIG. 2 illustrates an exemplary screen shot of a graphical user interface (“GUI”) for SMS gifting for accessing a business according to an embodiment of the present invention;

FIG. 3 illustrates an exemplary screen shot of a GUI for ordering a gift at a business according to an embodiment of the present invention;

FIG. 4 illustrates another exemplary screen shot of a GUI for ordering a gift a business according to an embodiment of the present invention;

FIG. 5 illustrates another exemplary screen shot of a GUI for confirming and purchasing selected goods and/or services for a recipient according to an embodiment of the present invention;

FIG. 6 illustrates an exemplary screen shot of a database for ordering a gift via SMS according to an embodiment of the present invention;

FIG. 7 illustrates an exemplary screen shot of a GUI for displaying a SMS purchase authorization code and gift to a recipient according to an embodiment of the present invention;

FIG. 8 illustrates an exemplary screen shot of a GUI for displaying a SMS purchase authorization code and gift to a user according to an embodiment of the present invention;

FIG. 9 is a block diagram of an exemplary process for ordering a gift at a business according to an embodiment of the present invention;

FIG. 10 is a block diagram of an exemplary process for providing a purchase authorization code and gift at a business according to an embodiment of the present invention;

FIG. 11 is a block diagram of another exemplary process for providing a purchase authorization code at a business according to an embodiment of the present invention.

### DETAILED DESCRIPTION OF THE DRAWINGS

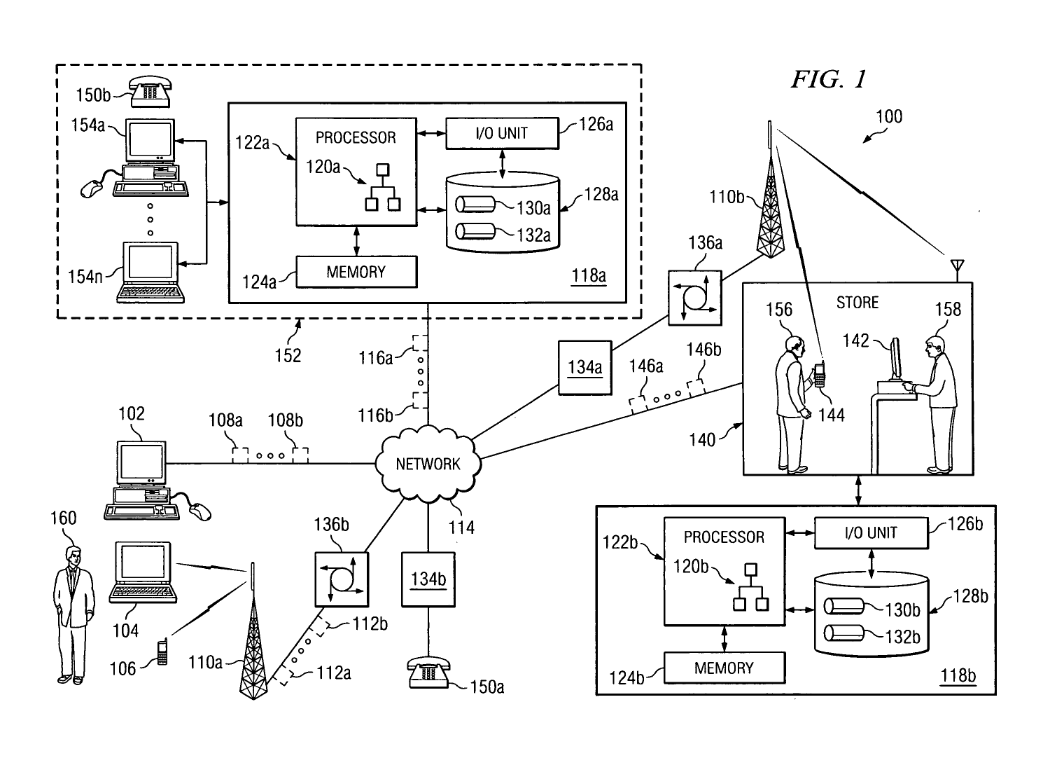

Like reference numerals are used to indicate like parts throughout the drawings. FIG. 1 is a block diagram of an exemplary network of a SMS gifting system 100. An exemplary recipient 156 user 158, and purchaser 160 are shown; however, any number of recipients, users, and purchasers may use the SMS gifting system 100. The SMS gifting system 100 may include various elements used for wireless and wired communication. The SMS gifting system 100 may include mobile switching centers (“MSCs”) 136a and 136b (136a and 136b collectively mobile switching centers 136), local exchanges 134a and 134b (134a and 134b collectively 134), network 114, retailer's online business 152 in communication with server 118a, a retailer's store 140 in communication with server 118b (118a and 118b collectively 118), transmission towers 110a and 110b (110a and 110b collectively 110), wireless communications devices 104, 106 and 144, host personal computer 102, wired communication devices 150a and 150b (150a and 150b collectively 150), and host personal computers 154a and 154n (154a and 154n collectively 154). In one embodiment, the different elements and components of the SMS gifting system 100 communicate using wireless communications including satellite connections or hardwired connections, such as fiber optics, T1, cable, DSL, high speed trunks, and telephone lines.

In one aspect, any number and location of retailer's store 140 may exist. The retailer's store 140 may be a chain of retail stores located throughout any location, for example. In one embodiment, the retailer's online business 152 may be a website or other electronic computing system capable of communicating through network 114 to the various retailer's stores 140. Further, a user, such as purchaser 160 may be able to communicate with the retailer's online business 152 via any of the devices herein described.

The wireless communications devices 104, 106, and 144 may communicate with the transmission towers 110 using communications protocols, such as time division multiple access (“TDMA”), code division multiple access (“CDMA”), global systems for mobile (“GSM”) communications, personal communications systems (“PCS”), wireless local area network (“WLAN”), worldwide interoperability for microwave access (“WiMAX”), or other frequently used cellular and data communications protocols and standards. The wireless communications devices 104, 106, and 144 may further include mobile phones, cellular phones, Blackberry®, personal digital assistances (“PDA”), laptops, evolution data optimized (“EVDO”) cards, multi-mode devices, and other wireless communication devices and elements.

Communications within the SMS gifting system 100 may occur on any number of networks which may include wireless networks, data or packet networks, private networks, publicly switched telephone networks (“PSTN”), and wired networks. The networks of the SMS gifting system 100 may represent a single communication service provider or multiple communications services providers. The features of the embodiments may be implemented by one or more elements of the SMS gifting system 100 independently or as a networked implementation.

In one embodiment, the mobile switching centers 136 and transmission towers 110 are part of a wireless network that is operated by a wireless service provider. For example, the control signals and operational features may be performed by the mobile switching centers 136 and the wireless signals may be broadcast from the transmission towers 110 to the wireless communications devices 104, 106, and 144. The wireless network may include any number of systems, towers, servers, and other network and communications devices for implementing the features and performing the methods herein described.

The MSCs 136 maybe a switch used for wireless call control and processing. The MSCs 136 may also serve as a point of access to the local exchanges 134. The MSCs 136 are a telephone exchange that provides circuit switched calling and mobility management and may also provide GSM or PCS services to the wireless communications devices 104, 106, and 144 located within the area the MSCs 136 serve. The MSCs 136 may include a home locator record (“HLR”) and virtual locator record (“VLR”) that may be used to implement different features of the illustrative embodiments.

A user may interact or send and receive data, information, and commands through the wired communication devices 150, wireless communications devices 104, 106, and 144, and servers 118. The MSCs 136 may include any number of hardware and software components. In one embodiment, the MSCs 136 is an advanced intelligence network device with software modules equipped to perform outbound greeting features and functions.

The local exchanges 134 and MSCs 136 communicate using a signal control protocol, such as a signaling system number 7 (“SS7”) protocol. The SS7 protocol is used in publicly switched networks for establishing connections between switches, performing out-of-band signaling in support of the call-establishment, billing, routing, and implementing information-exchange functions of a publicly switched network. The local exchanges 134 may be owned and operated by a local exchange carrier that provides standard telephone service to any number of users. In one embodiment, the local exchanges 134 may be a class 5 switch that is part of the network systems of the local carrier. However, the local exchanges 134 may also be a Digital Subscriber Line Access Multiplexer (“DSLAM”), Internet Protocol (“IP”) gateway, base station, or any other suitable network access point.

The local exchanges 134 may be a wire-line switch or public exchange using time domain multiplexing to provide telecommunications services to a particular subscriber or groups of subscribers. The local exchanges 134 may be located at a local telephone company's central office, or at a business location serving as a private branch exchange. The local exchanges 134 may provide dial-tone, calling features, and additional digital and data services to subscribers, such as wired communication devices 150. The local exchanges 134 may also enable voice over internet protocol (“VoIP”) communication of the wired communication devices 150 through a data network VoIP works by sending voice information in digital form in packets, rather than in the traditional circuit-committed protocols of the publicly switched network

The SMS gifting system 100 may further include any number of hardware and software elements that may not be shown in the example of FIG. 1. For example, in order to facilitate VoIP communications, the communications system and the MSCs 136 and local exchanges 134 in particular may include application servers, media servers, service brokers, call agents, edge routers, gateways (signaling, trunking, access, sub, etc.), IP network service providers, adapters, exchanges, switches, users, and networks. The local exchanges 134 or other components of a wire line network, such as a data, PSTN, VoIP, or other wired network may implement the features and perform the methods herein described.

The MSCs 136 and the local exchanges 134 may include an authentication space. The authentication space may be a partition of the server or other storage designated by the communications service provider. The authentication space may validate that a user or device, such as client, is allowed to authorize the MSCs 136 or local exchanges 134 to set preferences, implement changes, review information, or perform other updates. For example, a user may be first required to provide a secure identifier, such as a user name, password, or other authentication code or hardware interface, to verify the user is authorized to make changes within the authentication space.

The authentication information may be used to create a secure connection between the servers 118, local exchanges 134, and the MSCs 136. The secure connection may be a virtual private network tunnel, an encrypted connection, firewall, or other form of secured communications link. The MSCs 136 and local exchanges 134 may use any number of gateways, proxies, applications, or interfaces for allowing the servers 118 to the MSCs 136 and local exchanges 134 through the wired network 114. Alternatively, the servers 118 may use a wireless network or other network to access the MSCs 136 and local exchanges 134. The MSCs 136 and local exchanges 134 may use a host client application for communicating with numerous clients.

The retailer's store 140 is an example of a business or residence of a person or group that may use any number of communications services. The retailer's store 140 is shown as a store in the illustrated example, however, the retailer's store 140 may also be a warehouse, office, business, or other structure wired or otherwise suitably equipped to provide telephone, data, and other communication services to one or more customers. Any number of retailer's stores 140 may be employed in the SMS gifting system 100. In one embodiment, the retailer's store 140 is equipped with multiple communication devices, including wireless and wired communication devices and personal host computer 142. The wireless and wired communication devices may be standard devices that provide dialing and voice conversation capabilities. Wireless and wired communication devices and wired communication devices 150 may be integrated in any number of other devices or maybe used in different forms.

The servers 118 may be a personal computer for performing and executing programs and instructions and accessing the network 114. The servers 118 maybe any computing devices suitable for communicating with the network 114. The network 114 may be a fiber optic, cable, or telephone network or other wired network or wireless network suitable for communication with the servers 118. In one embodiment, the retailer's store 140 may include a wireless router, adapter, switch, hub, or other suitable interface that allows the servers 118 to communicate with the network 114. The MSCs 136 and local exchanges 134 may use a GUI, such as website or program accessible from the servers 118 in order to perform the features and functions herein described.

Additionally, the servers 118 may include processors 122a and 122b (122a and 122b collectively 122) that executes software 120a and 120b (120a and 120b collectively 120). The processors 122 may be in communication with memories 124a and 124b (124a and 124b collectively 124), an input/output (“I/O”) unit 126a and 126b (126a and 126b collectively 126), and a storage units 128a and 128b (128a and 128b collectively 128). The storage units 128 may store databases or data repositories 130a-130b and 132a-132b thereon. The software 120 may include instructions for execution by the processor processors 122 for providing network connectivity and computer status information in accordance with the principles of the present SMS gifting system 100. The server servers 118 may be physically located or utilized by the retailer's online business 152 and retailer's store 140.

Each of the servers 118 may communicate via the network 114. The network 114 may be the Internet, intranet, wide area networks (“WANs”), local area networks (“LANs”), or other communication systems capable of communicating information between computing devices. The servers 118, host personal computer 102, wireless communications devices 104, 106, and 144, retailer's store 140 may communicate data packets 116a-116b, 146a-146b, and 112a-112b containing information related to any of the computer and networks of a business to another server 118, as understood in the art. Similarly, the servers 118 may communicate information to the servers 118 via data packets 116a-116b, 146a-146b, and 112a-112b, respectively, via the network 114. In addition, network 114 maybe a communications network a computer network an internet network or a combination of them, and the like.

In operation, the servers 118 may execute the software 120 to enable a user to purchase goods, services, and gift amounts and to deliver these goods, services, and gift amounts via electronic purchase authorization codes to recipients who may present them to the retailer's store 140 for redemption, for example. For instance, a user may utilize host personal computer 102, wired communication devices 150, and wireless communications devices 104, 106, and 144 either directly with the servers 118 or indirectly via the network 114 or other telecommunications networks. The host personal computer 102 and wireless communications devices 104, 106, and 144 may enable users of the SMS gifting system 100 to interface with the software 120 to display online menus, catalogs, and the like to a user. Host personal computer 102, wired communication devices 150, and wireless communications devices 104, 106, and 144 may also include other peripherals, such as keyboards, displays, microphones, and the like. Preferably, the software contained in the host personal computer host personal computer 102, personal host computer 142, and wireless communications devices 104, 106, and 144 and the software 120 of the servers 118 is capable of presenting the GUIs described below to their respective displays. Moreover, some or all of the GUIs discussed herein maybe electronic commerce websites and webpages as are commonly known in the art.

One feature of software 120 is that it enables users to purchase goods, services, and gift amounts by using host personal computer 102 and wireless communications devices 104, 106, and 144 to view and purchase gifts, such as goods, services, and gift amounts, available from a particular business. As discussed further below, once a purchase is made a user receives a purchase authorization code that is sent to a recipient via by a text message that may be presented to the business for redeeming the gift.

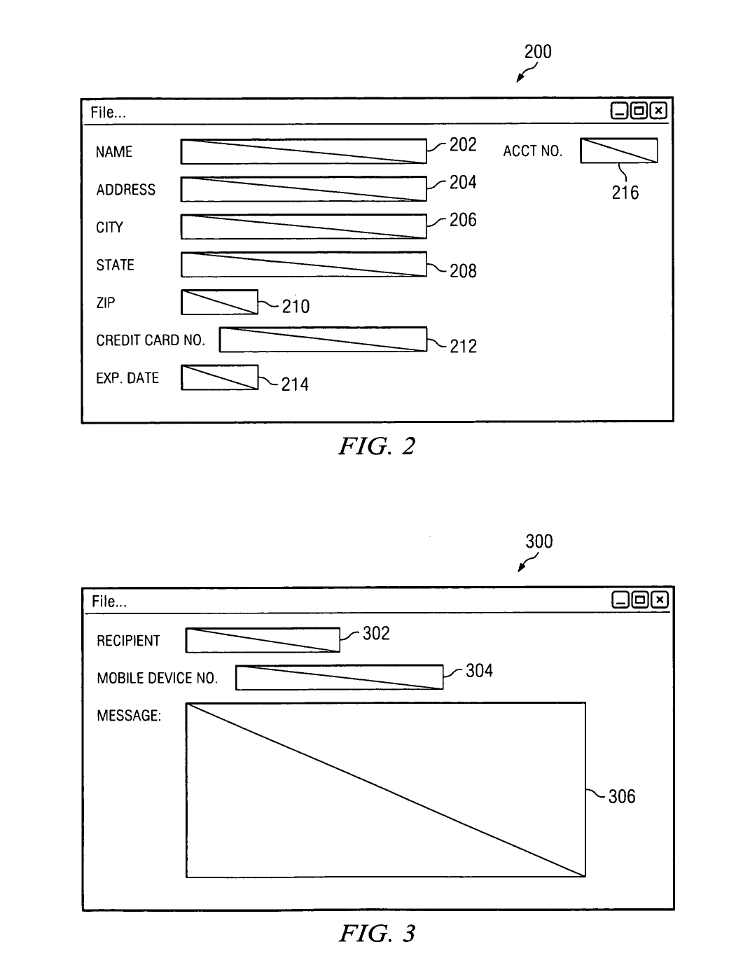

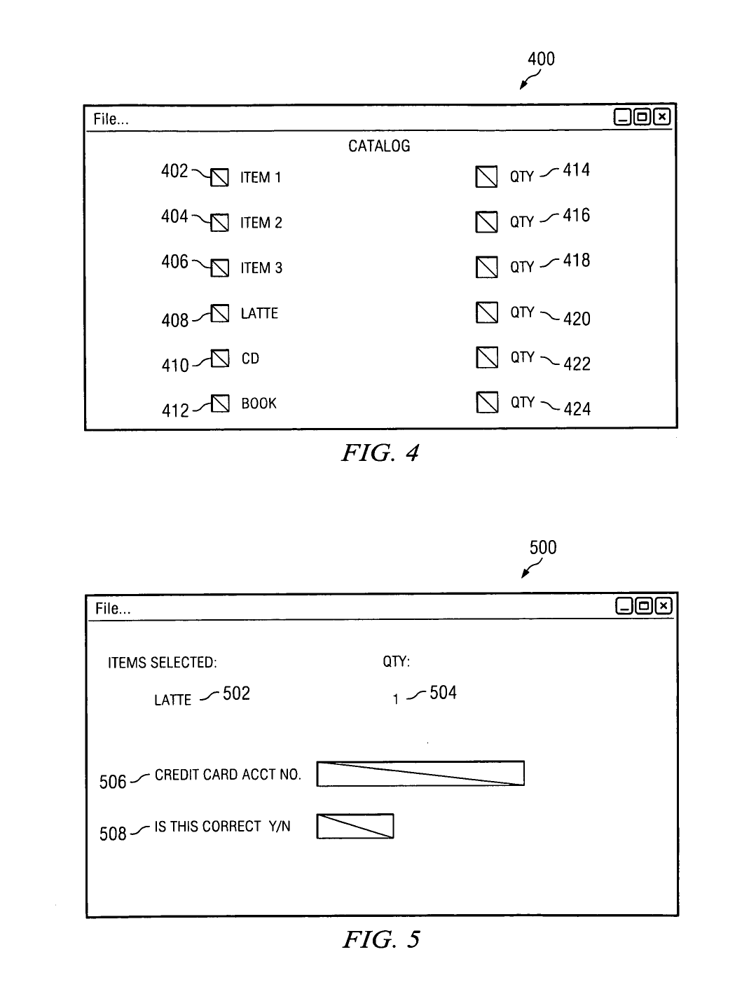

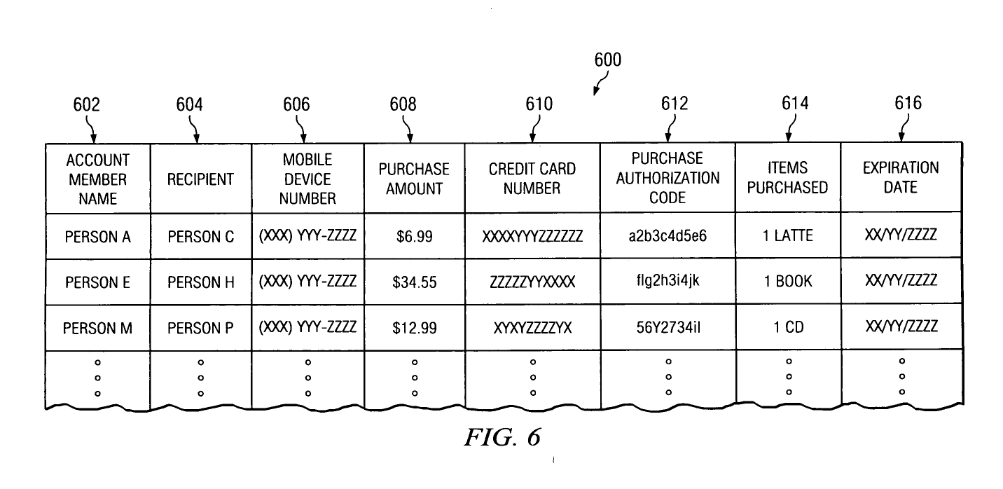

FIG. 2 illustrates an embodiment 200 of an exemplary screen shot of a user login GUI showing several data input fields relating to a purchaser of a gift. For example, the GUI 200 includes a name field 202, address field 204, city field 206, state field 208, zip code field 210, credit card number field 212, and expiration date field 214. These fields may be used to input this information relative to a purchaser who may not already have an account set up with a particular business. Should a user have an existing account with a particular business, then they may enter their account number in the account number field 216. Once the user is recognized as a known user with the SMS gifting system 100, then they may be directed to another GUI, such as that of embodiment 300 of exemplary screen shot of recipient information GUI.

Referring to FIG. 3, GUI 300 may include several fields that are related to the recipient of the gift, such as recipient name field 302, mobile phone number field 304, and message field 306. These fields may be completed by a user/purchaser to note the particular recipient to receive the gift or gifts purchased by a user. Once completed, the mobile phone number field 304 will include the phone number of the wireless communications device 144 of the recipient to receive the SMS or text message containing the purchase authorization code as further described herein. A message or greeting to be included with the delivery of the purchase authorization code may be completed and may be transmitted to the wireless communications device 144 as described herein.

Referring to FIG. 4, an embodiment 400 an exemplary screen shot of a catalog display GUI is shown. The GUI 400 preferably includes a selection of all or some of the goods and/or services offered by a particular business for purchase by a user. For example, items 1-3 noted as 402-406 and their corresponding quantity fields noted as 414-418 are shown in addition to latte 408, CD 410, and book 412 and their corresponding quantity fields 420-424. These items may be any goods and/or services offered by a particular business for purchase. If a user wishes to purchase a latte for a friend that they know will be or is enroute to a particular coffee shop, then the user may select or click the latte 408 field and enter the number of lattes they wish to purchase for their friend in quantity field 420.

Referring to FIG. 5, an embodiment 500 of an exemplary screen shot of a purchase display GUI is shown. Once all of the items to be purchased have been selected, a user then may proceed to the check-out or purchase display GUI 500, which may include a listing of all the items selected for purchase field 502 by a user and their corresponding quantity field 504 for each. In this example, only a latte is shown; nevertheless, any types or goods and/or services and their corresponding quantities may be selected for purchase. In addition, a gift amount, instead of goods and/or services may be selected for purchase. The credit card account number field 506 may contain the inputted credit card information from the login GUI 300 as described above. The GUI 500 may further include a confirmatory inquiry regarding the purchase, such as “is this correct y/n?” field 508 for confirming the type of goods and/or service, quantities, and credit card account information to be charged for the purchase. Once the purchase is completed, then the SMS gifting system 100 may create a database entry and generate a purchase authorization code to be sent to the recipient and

Referring to FIG. 6, an exemplary database 600 is shown. The database 600 may be a display of a relational, or otherwise, database that contains the data or information as entered on any or all of the GUIs herein described. For example, the database 600 may include all of the purchaser or account member names 602, recipients 604, phone numbers of the wireless communications devices 104, 106, and 144 corresponding to each specific recipient 606, purchase amount information 608, credit card account information 610, purchase authorization code 612, items purchased 614, and expiration date of the credit card 616. The database may be located or operate at storage units 128, host personal computers 154, or personal host computer 142 and may contain the data or information of a user or purchaser as described herein. In one embodiment, the software 120 operating with the database, storage units 128, host personal computers 154, or personal host computer 142 may generate a unique purchase authorization code 612 that is transmitted to the wireless communications devices of a recipient and/or user along with any additional greetings or messages provided by a user or purchaser. The unique purchase authorization code 612 corresponds to the items purchased by a particular purchaser or user.

In addition to sending the unique purchase authorization code 612 it is stored on the database for accessing from or transmitting any or all of the retailer's stores 140. It may further be stored to the servers 118 for access by a user 158. Some or all of the information relating to each purchase may be “pushed” or “pulled,” as is commonly known to those skilled in the art, from the retailer's online business 152 to each retailer's store 140.

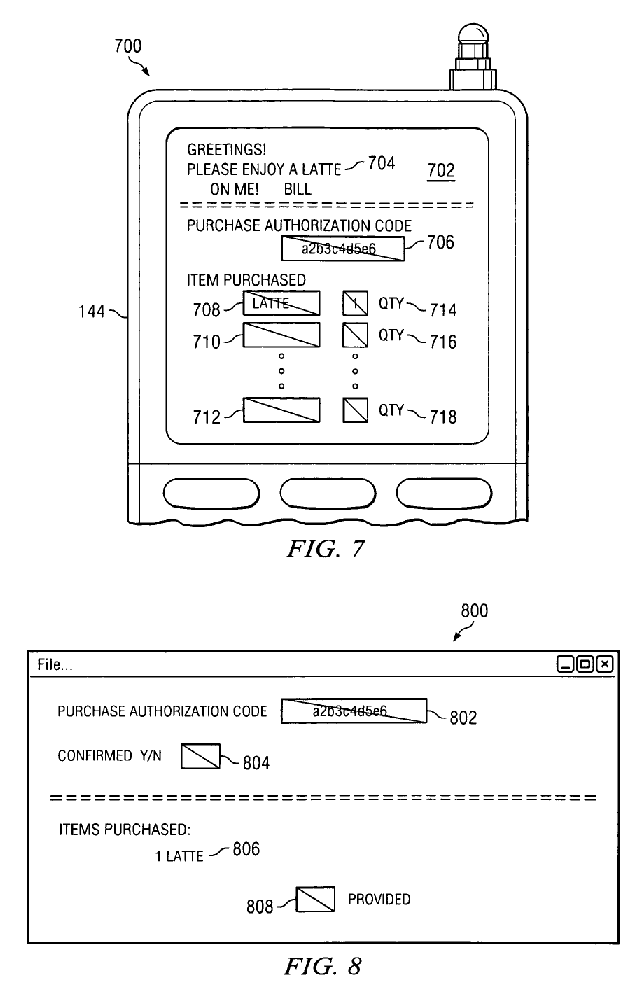

Referring to FIG. 7, an embodiment 700 of an exemplary screen shot of a wireless communications device 144 is shown displaying a purchase authorization code and related gifts or items to a recipient that have been purchased by the purchaser. In this embodiment, the wireless communications device 144 includes a display 702 for displaying a SMS or text message to a recipient noting a message 704, purchase authorization code 706, items purchased 708-712, and quantity 714-718. Preferably, the message 704 contains the content of the message that may have been entered into the message field 306 by the purchaser or user. This data or information is transmitted to the recipient's 156 wireless communications device 144 from the retailer's online business 152 upon a user or purchaser completing a purchase for the recipient. This enables the recipient 156 to view the data and present it to a user 158 located at a particular retailer's store 140 that offers the items or gifts purchased by the purchaser 160. In one embodiment, the data or information is presented as a short message service (“SMS”) or text message.

Referring to FIG. 8, an embodiment 800 of an exemplary screen shot of a purchase authorization confirmation GUI is shown as maybe presented to a user 158 once they have received or been shown the purchase authorization code 612 from the recipient 156 as it may be displayed on their wireless communications device 144. Once the purchase authorization code 612 has been presented or shown to a user 158, it may be entered into the purchase authorization code field 802 of the purchase authorization confirmation GUI 800 of the personal host computer 142. The SMS gifting system 100 then searches the database 600 to confirm that the purchase authorization code 612 is valid and if so displays the item(s) that correspond to that particular purchase authorization code 612. If the SMS gifting system 100 confirms the purchase authorization code 612, then it may display a “yes” indicia in confirmed field 804 and the item in items purchased field 806. The user 158 may then provide the goods and/or service that relates to that particular item(s). Once the item(s) have been provided, the user may select the provided field 808 or this may be done automatically by the SMS gifting system 100.

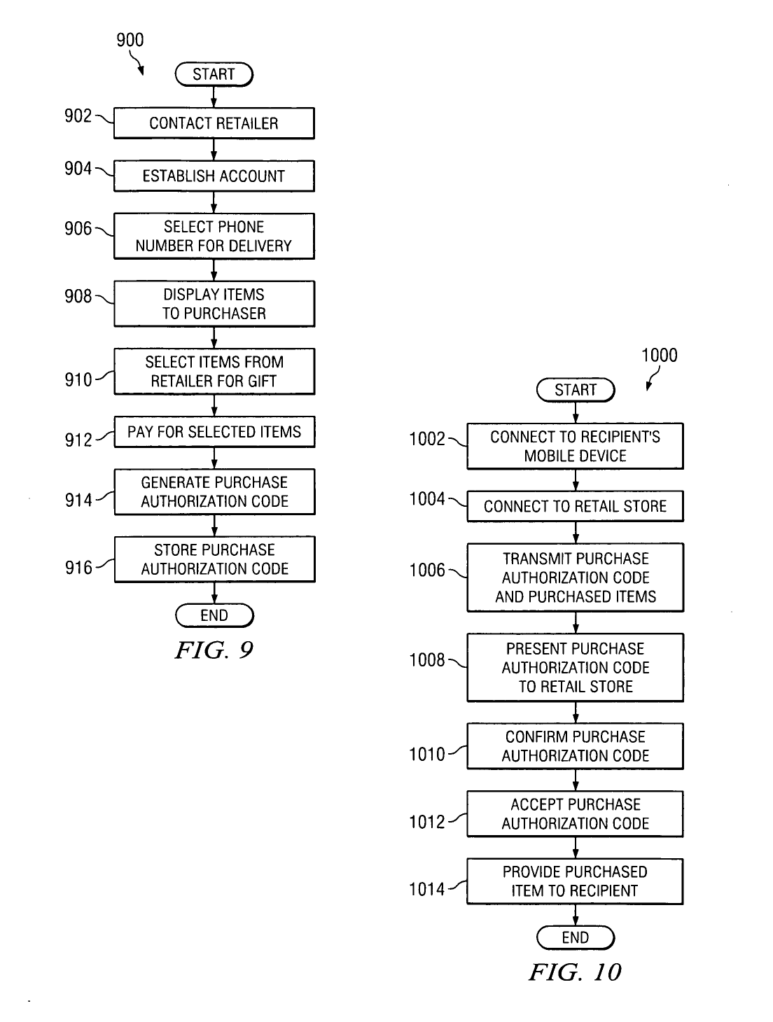

In addition to the aforementioned aspects and embodiments of the present SMS gifting system 100, the present invention further includes a method for SMS gifting. FIG. 9 is a flowchart of an embodiment 900 of a process for purchasing items or gifts from a retailer's online business 152 and/or retailer's store 140. In step 902, a purchaser 160 communicates or contacts a retailer's online business 152 and/or retailer's store 140 by using their wireless communications devices 104, wireless communications device 106, and/or wired communication device 150a. In step 904, an account is logged into or established. This step may include accessing the GUI 200 and entering information about themselves including credit card account information into the name field 202, address field 204, city field 206, state field 208, zip code field 210, credit card number field 212, and expiration date field 214. In another aspect, a purchaser 160 may enter an existing account number in the account number field 216. The account number may be set up in advance or during one of the previous visits to the retailer's online business 152.

In step 906, the purchaser 160 enters the name and telephone number of the wireless communications device 144 of the recipient into the field recipient field 302 and the mobile device number field 304 of GUI 300. These fields may auto-populate with stored data from previous data entries made by the purchaser as is commonly known in the art. In step 908, the retailer's online business 152 displays to the purchaser 160 the items or catalog of items of goods/services offered by the retailer's online business 152 and retailer's store 140 as shown in GUI 400. This step may include searching a database of servers 118 for those goods/services that are available at the time of inquiry. The items or gifts may be displayed to the purchaser's 160 host personal computer 102, wireless communications devices 104 and 106. It may also be presented on the purchaser's wired communication device 150a through auditory commands and menus. In one embodiment, the GUIs associated with a particular retailer's online business 152 may be e-commerce websites or webpages.

In step 910, the purchaser 160 selects those items or gifts and the desired quantities by selecting or entering information in the appropriate field on the GUI 400. For example, if the purchaser 160 desires to send a latte from a particular coffee shop to a friend or recipient 156, she may select latte 408 and select the number of lattes she is interested in buying for the recipient 156 by selecting the desired quantity in the corresponding quantity field 420. If she also desires to purchase a book for the recipient 156, then she may select the book 412 and corresponding quantity 424. Any number of items or gifts may be purchased with the SMS gifting system 100.

In step 912, the items that were selected by the purchaser 160 are then paid for by the purchaser at GUI 500, preferably. This step may include selecting an existing credit card account already stored in the SMS gifting system 100 or entering a different credit card account number in credit card account number field 506. In another embodiment, other payment indicia may be entered in this field, such as a gift card number and the like. The selected items or gifts are displayed in the fields selected for purchase 502 and the corresponding quantity in the corresponding quantity field 504. The purchaser confirms the purchase by selecting “yes” in the confirmation field “is this correct y/n,” for example. Once the purchase is complete, then the SMS gifting system 100 stores the inputted information in a database 600, such as storage units 128 as in step 916.

FIG. 10 is a flowchart of an embodiment 1000 of a process for providing a purchase authorization code and corresponding items or gifts. In step 1002, the SMS gifting system 100 connects to the recipient's 156 wireless communications device 144. The SMS gifting system 100 uses the SMS or text messaging technology of the SMS gifting system 100 to connect using the telephone number provided in the mobile device number field 304 of the GUI 300. In step 1004, the SMS gifting system 100 connects to the retailer's store 140 via network 114 or other telecommunications or data network as described herein. In step 1006, the SMS gifting system 100 generates a unique purchase authorization code 612 and inputs that code in the database 600, as described herein, and communicates or transmits the purchase authorization code 612 to the retailer's store 140 and recipient 156. In one aspect, this information is then “pushed” via the network 114 or other communication means to some or all of the retailer's stores 140 for storage at storage units 128. In another aspect, this information is available to be “pulled” from the retailer's online business 152 by some or all of the retailer's stores 140. Some or all of this information is also communicated to the recipient's 156 wireless communications device 144 for displaying to the recipient 156.

In step 1008, the recipient 156 presents the purchase authorization code 612 to a user 158 located in a particular retailer's store 140. This step may include showing the purchase authorization code 612 as displayed in the display 702 of the wireless communications device 144 to the user 158 at the retailer's store 140. In step 1010, the user 158 may enter the purchase authorization code 612 into the purchase authorization code field 802 of the GUI 800 as displayed on the personal host computer 142, for example. In one aspect, this step may include the personal host computer 142 then accessing the storage units 128 to determine whether the purchase authorization code 612 is a valid. In another aspect, this step may include the personal host computer 142 accessing confirmation by communicating with the retailer's online business 152 for validating the purchase authorization code 612, as in step 1012. In step 1014, the items or gifts are provided to the recipient 156 upon confirmation of the purchase authorization code 612.

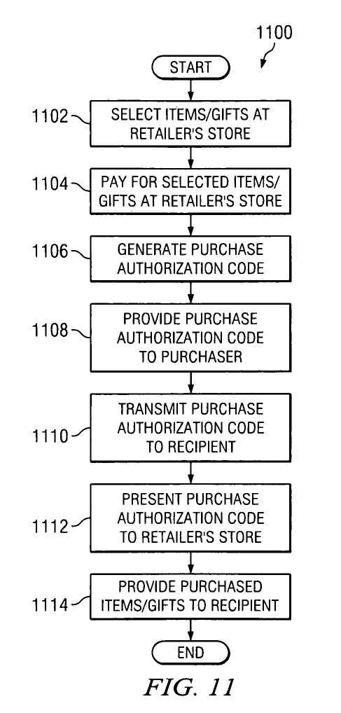

FIG. 11 is a flowchart of an embodiment 1100 of a process for providing a purchase authorization code and corresponding items or gifts to a recipient. In this embodiment, a purchaser 160 may not access the retailer's online business 152 or retailer's store 140 over a network to purchase the items or gifts, but rather the purchaser 160 actually is present within any of the retailer's stores 140 and selects and purchases the items or gifts at the retailer's store 140. In step 1102, a purchaser 160 visits a retailer's store 140 and selects those items or gifts that she wishes to give to a 156. Once the purchaser 160 has selected the items or gifts at the retailer's store 140 that she wishes to purchase, then in step 1104, she pays for the gifts and items by any means of conventional or acceptable commerce.

In step 1106, the retailer's store 140 then generates a purchase authorization code for the purchase. The servers 118 and related databases 600 store the items purchased 614 and the generated purchase authorization code. In step 1108, the purchase authorization code is provided to the purchaser 160 at the retailer's store 140. This step may include handing the purchaser 160 a paper receipt that contains the purchase authorization code or verbally giving the purchase authorization code to the purchaser 160. Any other means for providing the purchase authorization code to the purchaser 160 are also contemplated.

In step 1110, the purchase authorization code is transmitted from the purchaser 160 to the recipient 156 via SMS technology using wireless communications devices 144 and the like. This step may include the purchaser 160 creating a SMS or text message to the recipient 156 and including the purchase authorization code within the body of the SMS. This message is then transmitted to the recipient 156 via SMS technology as commonly known in the art and as described herein. In step 1112, the recipient 156 then may visit any of the retailer's stores 140 and present the purchase authorization code to the user 158 for redemption of the items and gifts that the purchaser 160 purchased for the recipient 156. This step may include entering the purchase authorization code into the personal host computer 142, which then may communicate to the servers 118 to confirm the stored purchase authorization code and corresponding items and gifts.

There has been described an SMS gifting system. It should be understood that the particular embodiments described within this specification are for purposes of example and should not be construed to limit the invention. Further, it is evident that those skilled in the art may now make numerous uses and modifications of the specific embodiment described, without departing from the inventive concepts. For example, particular additional servers, computers, networks and the like maybe used to convey the information and data for such purchases without departing from the inventive concepts.

What is claimed:

1. A system for SMS gifting comprising:
a central online computer of a commercial business in communication with a network comprising:
a processor for generating a purchase authorization code and an indicia describing a purchase by a purchaser of at least one of goods, services, and gift amounts relating to the commercial business;
a memory for storing information relating to the at least one of goods, services, and gift amounts of the commercial business and the generated purchase authorization code;
an input/output unit for transmitting the generated purchase authorization code and indicia describing the purchase of the at least one of goods, services, and gift amounts to a recipient;
a communications device in communication with the network the communications device operable by the purchaser and configured to:
receive the information relating to the at least one of goods, services, and gift amounts;
display the information to the purchaser relating to the at least one of the goods, services, and gift amounts;
responsive to purchaser input, purchase the at least one of the goods, services, and gift amounts;
a wireless communications device in communication with the network operable by the recipient and configured to:
receive the generated purchase authorization code and indicia describing the purchase of the at least one of goods, services, gift amounts;
display to the recipient the generated purchase authorization code and indicia describing the purchase of the at least one of goods, services, and gift amounts; and
a store providing the at least one of goods, services, and gift amounts of the commercial business, the store having a computer in communication with the central online computer, the computer comprising:
an input/output unit for receiving the generated purchase authorization code and indicia describing the purchase of the at least one of goods, services, and gift amounts;
a memory for storing the generated purchase authorization code and indicia describing the purchase of at least one of goods, services, and gift amounts;
an input device for accepting a purchase authorization code presented by the recipient;
a processor for comparing the presented purchase authorization code to the generated purchase authorization code for authorizing the provision at the store of the purchased at least one of goods, services, and gift amounts.

2. The system for SMS gifting of claim 1, wherein the communications device is a wired or wireless communications device comprising:
an input/output unit configured to communicate with the central online computer to receive the information relating to the at least one of goods, services, and gift amounts; and
a display for displaying to the purchaser the information relating to the at least one of goods, services, and gift amounts.

3. The system for SMS gifting of claim 1, wherein the presented purchase authorization code is presented by on the recipient's wireless communications device.

4. The system of SMS gifting of claim 1, wherein the network is at least one of Internet, Intranet, TDMA network, CDMA network, PCS network, GSM network, WiMAX network, WLAN, data network, packet network, private network, PSTN, and VoIP network.

5. The system of SMS gifting of claim 1, wherein the generated purchase authorization code and indicia describing the purchase of the at least one of goods, services, and gift amounts is displayed to the recipient in the form of one of a text message and SMS.

6. A system for SMS gifting comprising:
a first store configured to execute a sale of at least one of goods, services, and gift amounts by a purchaser, the first store having a computer in communication with a network, the computer comprising:
a processor for generating a purchase authorization code corresponding to the purchased at least one of goods, services, and gift amounts and an indicia describing the purchased at least one of goods, services, and gift amounts;
a memory for storing the indicia describing the purchased at least one of goods, services, and gift amounts and the generated purchase authorization code;
an input/output unit for transmitting the generated purchase authorization code and the indicia describing the purchased at least one of goods, services, and gift amounts to at least one of the purchaser, the first store, and a second store;
a first wireless communications device in communication with the network operable by the purchaser and configured to:
transmit at least one of the purchase authorization code and the indicia describing the purchased at least one of goods, services, and gift amounts; and
a second wireless communications device in communication with the network operable by the recipient and configured to:
receive the generated purchase authorization code and indicia describing the purchase of the at least one of goods, services, and gift amounts;
display to at least one of the recipient, the first store, and the second store the generated purchase authorization code and indicia describing the purchase of the at least one of goods, services, and gift amounts.

7. The SMS gifting system of claim 6, wherein the second store has a computer in communication with the network, the computer comprising:
an input/output unit for receiving the generated purchase authorization code and the indicia describing the purchased at least one of goods, services, and gift amounts;
a memory for storing the indicia describing the purchased at least one of goods, services, and gift amounts and the generated purchase authorization code; and
a processor for comparing the generated purchase authorization code and a presented purchase authorization code by the recipient.

8. The SMS gifting system of claim 6, wherein the network is at least one of Internet, Intranet, TDMA network, CDMA network, PCS network, GSM network, WiMAX network, WLAN, data network, packet network, private network, PSTN, and VoIP network.

9. The SMS gifting of claim 6, wherein the generated purchase authorization code and indicia describing the purchase of the at least one of goods, services, and gift amounts is displayed to the recipient in the form of one of a text message and SMS.

10. A method for sending to a recipient a purchase authorization code corresponding to a purchased gift by a purchaser comprising:
displaying information corresponding to at least one of goods, services, and gift amounts to a purchaser's communications device in communication with a network;
selecting at least one of goods, services, and gift amounts on the communications device by the purchaser;
purchasing the at least one of goods, services, and gift amounts;
responsive to the purchase, generating the purchase authorization code corresponding to the purchase; and
transmitting the purchase authorization code and indicia of the purchased at least one of goods, services, and gift amounts to the recipient's communications device.

11. The method for sending to a recipient a purchase authorization code of claim 10, wherein the displaying further comprises:
storing the information corresponding to at least one of goods, services, and gift amounts at a central online computer in communication with the network.

12. The method for sending to a recipient a purchase authorization code of claim 10, further comprising:
presenting the purchase authorization code to a business for redemption of the purchased at least one of goods, services, and gift amounts.

13. The method for sending to a recipient a purchase authorization code of claim 10, further comprising:
storing the generated purchase authorization code at the business.

14. The method for sending to a recipient a purchase authorization code of claim 13, further comprising:
comparing the presented purchase authorization code with the stored purchase authorization code to confirm whether to provide the purchased at least one of goods, services, and gift amounts to the recipient.

15. The method for sending to a recipient a purchase authorization code of claim 10, wherein the generating further comprises:
generating a unique purchase authorization code corresponding to the purchase; and
storing the purchase authorization code at the business.

16. The method for sending to a recipient a purchase authorization code of claim 10, wherein the transmitting further comprises:
transmitting to the recipient a message from the purchaser.

17. The method for sending to a recipient a purchase authorization code of claim 10, wherein purchasing further comprises:
transmitting the purchase authorization code and indicia of the purchased at least one of goods, services, and gift amounts to the recipient's communications device using the telephone number of the recipient's communications device.

18. A system for sending to a recipient a purchase authorization code corresponding to a purchased gift by a purchaser comprising:
means for displaying information corresponding to at least one of goods, services, and gift amounts to a purchaser's communications device in communication with a network;
means for selecting at least one of goods, services, and gift amounts on the communications device by the purchaser,
means for purchasing the at least one of goods, services, and gift amounts;
responsive to the purchase, means for generating the purchase authorization code corresponding to the purchase; and
means for transmitting the purchase authorization code and indicia of the purchased at least one of goods, services, and gift amounts to the recipient's communications device.

19. The system for sending to a recipient a purchase authorization code of claim 18, wherein the means for displaying further comprises:
means for storing the information corresponding to at least one of goods, services, and gift amounts at a central online computer in communication with the network.

20. The system for sending to a recipient a purchase authorization code of claim 18, further comprising:
means for presenting the purchase authorization code to a business for redemption of the purchased at least one of goods, services, and gift amounts.

21. The system for sending to a recipient a purchase authorization code of claim 18, further comprising:
means storing the generated purchase authorization code at the business.

22. The system for sending to a recipient a purchase authorization code of claim 21, further comprising:
means for comparing the presented purchase authorization code with the stored purchase authorization code to confirm whether to provide the purchased at least one of goods, services, and gift amounts to the recipient.

23. The system for sending to a recipient a purchase authorization code of claim 18, wherein the means for generating further comprises:
means for generating a unique purchase authorization code corresponding to the purchase; and
means for storing the purchase authorization code at the business.

24. The system for sending to a recipient a purchase authorization code of claim 18, wherein the means for transmitting further comprises:
means for transmitting to the recipient a message from the purchaser.

25. The system for sending to a recipient a purchase authorization code of claim 18, wherein the means for purchasing further comprises:
means for transmitting the purchase authorization code and indicia of the purchased at least one of goods, services, and gift amounts to the recipient's communications device using the telephone number of the recipient's communications device.
